(19) United States
(12) Patent Application Publication
(10) Pub. No.: US 2026/0080476 A1
(43) Pub. Date: Mar. 19, 2026

(54) SYSTEM FOR ENHANCED DATA MANAGEMENT USING DISTRIBUTED EDGE COMPUTING

(71) Applicant: BANK OF AMERICA CORPORATION, CHARLOTTE, NC (US)

(72) Inventors: Pratap Dande, Saint Johns, FL (US); Brian Neal Jacobson, Granada Hills, CA (US); Noell York Eury, Stanfield, NC (US); Dennis Vranjesevic, Kent Cliffs, NY (US); Tony Aidoo, Aubrey, TX (US); Rahul Yaksh, Austin, TX (US); Bojan Zdravkovic, Jersey City, NJ (US)

(73) Assignee: BANK OF AMERICA CORPORATION, CHARLOTTE, NC (US)

(21) Appl. No.: 18/889,018

(22) Filed: Sep. 18, 2024

(51) Int. Cl. G06Q 40/06; G06F 16/27; G06F 21/62

(52) U.S. Cl. CPC G06Q 40/06; G06F 16/27; G06F 21/6245; G06F 2221/2101

(57) ABSTRACT

Systems, computer program products, and methods are described herein for enhanced data management using distributed edge computing. An example TMO system receives data from trustee endpoint devices over a network. The data comprises trust-related information, which the system transforms for compatibility with existing legacy systems. The transformation process includes converting data formats, reconciling records, and synchronizing databases to integrate the transformed data with the legacy systems effectively. The example TMO system synchronizes trust-related data in real-time between the trustee endpoint devices and legacy systems, thereby maintaining consistent data states and providing real-time access to the data for authorized stakeholders via a secure web portal.

### TECHNOLOGICAL FIELD

Example embodiments of the present disclosure relate to field of data management systems, particularly utilizing distributed edge computing technology.

### BACKGROUND

In data management systems, especially those involving sensitive or high-volume data, there is a growing need for efficient, secure, and real-time data processing. Traditional centralized data management systems, which rely on centralized servers and legacy technologies, face significant challenges in meeting these needs. Centralized systems often act as bottlenecks due to high data traffic and processing loads, leading to increased latency and delayed decision-making. Moreover, centralized architectures create single points of failure, making them vulnerable to security breaches, unauthorized access, data corruption, and system downtimes.

Applicant has identified a number of deficiencies and problems associated with traditional data management systems that rely on centralized processing and storage infrastructure. Many of these identified problems have been solved by developing solutions that are included in embodiments of the present disclosure, many examples of which are described in detail herein.

### BRIEF SUMMARY

Systems, methods, and computer program products are provided for enhanced data management using distributed edge computing.

In one aspect, a TMO system for enhanced data management using distributed edge computing is presented. The system comprising: a processor; a non-transitory storage device containing instructions that, when executed by the processor, cause the processor to: receive data from a trustee endpoint device over a network, wherein the data comprises trust-related information; transform the received data for compatibility with existing legacy systems, wherein transforming further comprises converting data formats, reconciling records, and synchronizing databases; integrate the transformed data with the existing legacy systems; synchronize trust-related data in real-time between the trustee endpoint device and existing legacy system, thereby maintaining consistent data states; and provide real-time access to the data to authorized stakeholders via a secure web portal, wherein the TMO system and the trustee endpoint device are edge computing devices.

In some embodiments, the instructions, when executed by the processor, further cause the processor to: receive real-time transaction data from the trustee endpoint device, wherein the real-time transaction data comprises at least one of time stamps, transaction types, involved parties, or transaction amounts; verify authenticity of the real-time transaction data based on predefined set of parameters; update transaction logs with the real-time transaction data and an outcome of the verification, thereby generating an audit trail; and provide real-time access to the transaction logs and the audit trail to the authorized stakeholders via the secure web portal.

In some embodiments, the instructions, when executed by the processor, further cause the processor to: execute compliance monitoring algorithms on the real-time transaction data to analyze the real-time transaction data against current regulatory requirements and predefined compliance rules to identify exposure activities or potential compliance breaches; in an instance in which exposure activities or potential compliance breaches is identified, generate an alert; and transmit the alert to the trustee endpoint device.

In some embodiments, the instructions, when executed by the processor, further cause the processor to: log the exposure activities or potential compliance breaches in a secure, immutable audit trail stored locally on the TMO system.

In some embodiments, the instructions, when executed by the processor, further cause the processor to: receive financial data from the trustee endpoint device, wherein the financial data comprises at least one of investment performance metrics, market data, or operational metrics; execute, in real-time, using exposure management algorithms, an exposure framework for the financial data; compile the financial data and the exposure framework into a personalized financial report; and transmit the personalized financial report to the authorized stakeholders via the secure web portal.

In some embodiments, the instructions, when executed by the processor, further cause the processor to: receive investment data from the trustee endpoint device, wherein the investment data comprises at least one of portfolio allocations, resource performance, and market conditions; execute real-time analytics on the investment data to monitor performance of investments against benchmarks; evaluate current investment strategies based on executing the real-time analytics; and transmit the evaluation of the current investment strategies and alternate investment strategies to the trustee endpoint device.

In some embodiments, the instructions, when executed by the processor, further cause the processor to: receive, from the trustee endpoint device, a notification of a trustee change; execute a backup of metadata associated with transactions executed using the trustee endpoint device, wherein the metadata comprises at least one of relevant trust data, records, or transaction histories associated with a current trustee; and synchronize the metadata with a new trustee endpoint device.

In some embodiments, in synchronizing the metadata, the instructions, when executed by the processor, further cause the processor to: update access controls and permissions with the new trustee endpoint device to mirror access controls and permissions associated with the trustee endpoint device.

In another aspect, a computer program product for enhanced data management using distributed edge computing is presented. The computer program product comprising a non-transitory computer-readable medium comprising code configured to cause an apparatus to: receive data from a trustee endpoint device over a network, wherein the data comprises trust-related information; transform the received data for compatibility with existing legacy systems, wherein transforming further comprises converting data formats, reconciling records, and synchronizing databases; integrate the transformed data with the existing legacy systems; synchronize trust-related data in real-time between the trustee endpoint device and existing legacy system, thereby maintaining consistent data states; and provide real-time access to the data to authorized stakeholders via a secure web portal, wherein the TMO system and the trustee endpoint device are edge computing devices.

In yet another aspect, a method for enhanced data management using distributed edge computing is presented. The method comprising: receiving data from a trustee endpoint device over a network, wherein the data comprises trust-related information; transforming the received data for compatibility with existing legacy systems, wherein transforming further comprises converting data formats, reconciling records, and synchronizing databases; integrating the transformed data with the existing legacy systems; synchronizing trust-related data in real-time between the trustee endpoint device and existing legacy system, thereby maintaining consistent data states; and providing real-time access to the data to authorized stakeholders via a secure web portal, wherein the TMO system and the trustee endpoint device are edge computing devices.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for enhanced data management using distributed edge computing, in accordance with an embodiment of the disclosure;

FIG. 2 illustrates an example machine learning (ML) subsystem architecture, in accordance with an embodiment of the invention;

FIG. 3 illustrates an example method for synchronizing trust-related data between trustee endpoint device and existing legacy system, in accordance with an embodiment of the invention;

FIG. 4 illustrates an example method for continuously updating transaction logs with real-time transaction data, in accordance with an embodiment of the invention;

FIG. 5 illustrates an example method for generating a personalized financial report, in accordance with an embodiment of the invention; and

FIG. 6 illustrates an example method for generating a personalized financial report, in accordance with an embodiment of the invention.

### DETAILED DESCRIPTION

### Overview

The disclosure involves a system and method for enhanced data management through the deployment of edge computing devices that perform decentralized, real-time data processing, secure data transmission, compliance monitoring, and synchronization across multiple nodes within a network. The edge computing devices are configured to operate independently at various locations within a distributed network, allowing for efficient data handling, reduced latency, improved security, and operational continuity without relying on centralized data processing infrastructure.

The technical problem addressed by the disclosure is the inefficiency, latency, and security vulnerabilities associated with traditional centralized data management systems, especially those that rely on legacy technologies and centralized servers for data processing and storage. Centralized systems often create bottlenecks due to high data traffic and processing loads, leading to delays and increased latency. These systems also represent single points of failure, which heightens the exposure of data breaches, unauthorized access, data corruption, and system downtime. Furthermore, centralized systems face challenges in dynamically adapting to evolving compliance requirements and ensuring real-time data synchronization across different network nodes, which can result in inconsistent data states, potential non-compliance, and increased operational complexity.

In the context of trust management, centralized systems often create bottlenecks due to high data traffic and processing loads, such as when processing multiple transactions involving different beneficiaries or resource types. This leads to delays and increased latency, which can hinder timely decision-making and reduce the effectiveness of trust management operations. These systems also represent single points of failure, which heightens the exposure of data breaches, unauthorized access to sensitive financial and personal information, data corruption of trust records, and system downtime that can disrupt trust administration and beneficiary services. Furthermore, centralized systems in trust management face significant challenges in dynamically adapting to evolving compliance requirements, such as changes in financial regulations, anti-money laundering (AML) rules, or tax laws. This makes it difficult for real-time data synchronization across different network nodes, such as between the trust management organization and individual trustees, leading to inconsistent data states, potential non-compliance with fiduciary and legal obligations, and increased operational complexity in managing the trust. For example, when a trustee executes a transaction, the centralized system may struggle to immediately validate and synchronize the transaction data across all relevant nodes, resulting in delayed reporting and an increased exposure of regulatory breaches.

The disclosure solves these technical problems, particularly in the context of trust management, by implementing a distributed data management system using edge computing devices positioned at multiple nodes within the network, such as at the trust management organization (TMO) and trustee locations. These edge computing devices are designed to process trust-related data locally, performing real-time data validation, encryption, transaction management, and compliance checks specific to trust accounting requirements. By processing data at the edge of the network, the disclosure reduces latency associated with centralized data handling, enhances processing speed, and enables immediate data validation and execution of trust transactions, thereby supporting faster and more reliable decision-making in trust management operations.

The system enables secure, encrypted communication between edge devices over a decentralized network, eliminating the need for a central server to coordinate data flows related to trust transactions and records. This direct device-to-device communication facilitates real-time synchronization of transaction data, audit trails, and compliance records between the TMO and trustees, verifying consistent and accurate data states across all network nodes involved in managing the trust. The use of secure communication protocols and encryption methods enhances data security, reducing the exposure of unauthorized access to sensitive financial and personal information of beneficiaries and settlors, and mitigating the exposure of data breaches.

Additionally, the edge computing devices are equipped with algorithms for adaptive compliance monitoring, which are particularly important in the context of trust management. These algorithms allow the system to dynamically respond to changes in regulatory requirements, such as updates to tax laws, anti-money laundering (AML) regulations, and fiduciary obligations, verifying continuous compliance and reducing the exposure of regulatory violations that could affect the trust. The system also facilitates seamless data management during network changes, such as the addition or removal of trustees or changes in trust terms, by automatically synchronizing and updating data records, access controls, and transaction histories to reflect the current status of trust management.

By decentralizing data processing and storage, and providing secure, real-time communication and synchronization capabilities, the disclosure improves the overall efficiency, security, and reliability of trust management operations. This approach effectively addresses the technical problems associated with traditional centralized data management systems, enabling more agile and secure trust administration, improved compliance with dynamic regulatory requirements, and enhanced transparency and trust among beneficiaries and stakeholders.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example Distributed Edge Computing Environment

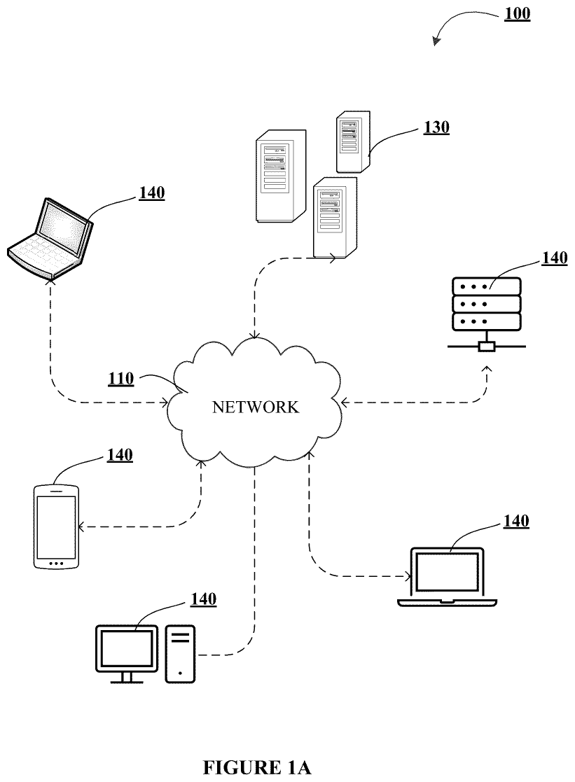

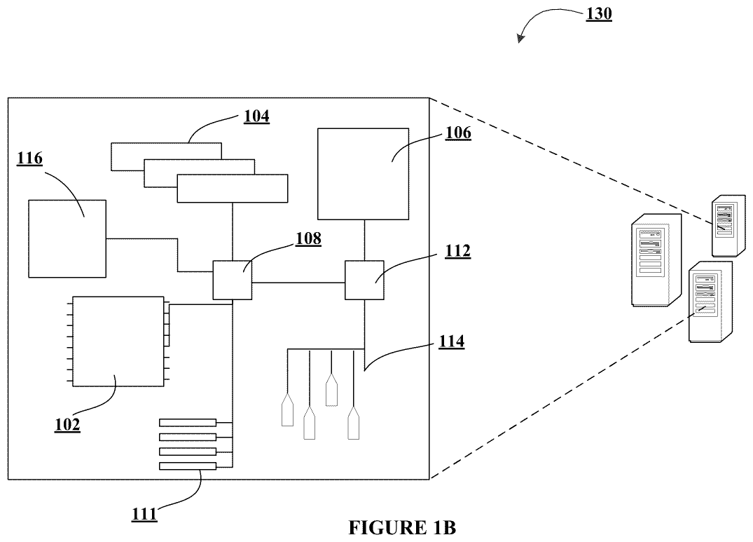

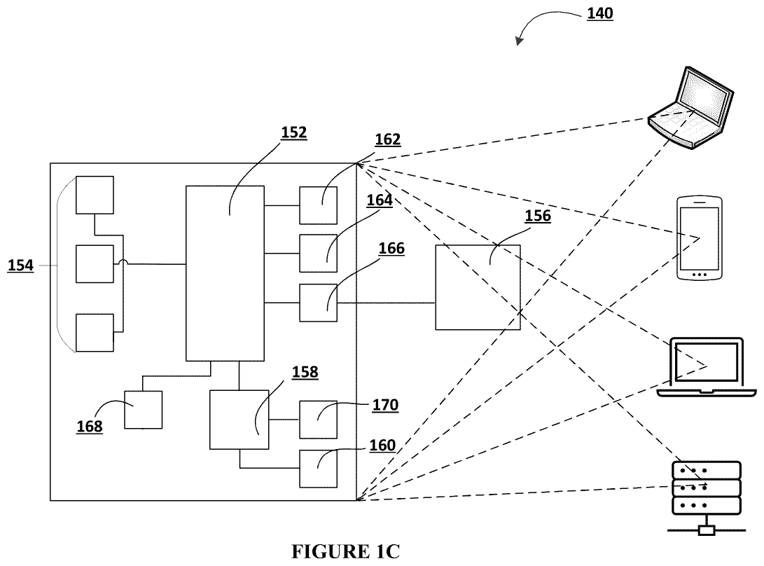

FIGS. 1A-1C illustrate technical components of an exemplary distributed computing environment for enhanced data management using distributed edge computing 100, in accordance with an embodiment of the disclosure. As shown in FIG. 1A, the distributed computing environment 100 in the present disclosure may integrate a distributed data management system utilizing edge computing devices. The distributed edge computing environment 100 may include a network 110, a Trust Management Organization (TMO) system 130, and multiple trustee locations represented by endpoint devices 140. These components may communicate with each other over the network 110 to perform decentralized, real-time data processing, secure communication, and data synchronization. It is to be understood that the distributed edge computing environment 100 described herein illustrates one embodiment of the distributed computing environment 100, and it will be appreciated that in other embodiments, one or more of the systems, devices, and/or servers may be combined into a single system or divided into multiple systems, devices, or servers. Additionally, the distributed computing environment 100 may include multiple TMO systems similar to system 130, each providing portions of the necessary operations (e.g., as a server bank, a cluster of edge devices, or a multi-processor system).

In some embodiments, the TMO system 130 may function as a central management node, with edge computing capabilities, coordinating data management and trust operations across multiple trustee locations represented by the endpoint devices 140. As an edge computing system, the TMO system 130 is capable of performing real-time data processing tasks, such as transaction validation, encryption, compliance checks, and exposure assessments locally, rather than relying solely on remote or centralized servers. Such local processing capability enhances the efficiency of data management by reducing the amount of data that needs to be transmitted back and forth between the TMO system 130 and the trustee endpoint devices 140, thereby minimizing latency, improving processing speed, and increasing data security by keeping sensitive information within localized environments.

These endpoint devices 140, located at the trustee sites, may also be equipped with edge computing capabilities that allow them to process data locally. Such local processing may include tasks such as transaction validation, encryption, compliance checks, and exposure assessments, thereby reducing the need to send all data to the TMO system 130 for centralized processing. Such local processing at the trustee sites further reduces the need to send all data to the TMO system 130 for centralized processing, supporting a more decentralized approach to data management. This decentralized approach leverages the edge computing capabilities of both the TMO system 130 and the trustee endpoint devices 140 to distribute computational loads, thereby enhancing system resilience, reducing reliance on any single point of failure, and maintaining robust data security protocols. In other embodiments, the TMO system 130 and the trustee endpoint devices 140 may operate in a peer-to-peer relationship, where both the TMO and trustee devices possess edge computing capabilities that allow them to independently use resources, process data, and manage trust operations on the network 110. In this peer-to-peer configuration, each trustee device and the TMO system 130 can function interchangeably as a client or server, facilitating a highly flexible and robust decentralized data management framework that supports distributed processing and storage, further enhancing the system's overall security, efficiency, and reliability.

The TMO system 130 may represent various forms of edge computing systems that serve as management nodes within a distributed network, facilitating coordination and oversight across multiple trustee locations. As an edge computing system, the TMO system 130 is capable of performing a range of tasks locally, including managing data integrity, coordinating updates across trustee endpoint devices 140, overseeing regulatory compliance, and providing disaster recovery support. By processing data locally at the edge of the network, the TMO system 130 reduces dependency on centralized servers, thereby minimizing latency and enhancing the speed and security of trust management operations. Additionally, the TMO system 130 may encompass a variety of digital computing devices, such as mainframes, workstations, and other specialized computing resources, that are configured to support the broader fiduciary management ecosystem. These devices, equipped with edge computing capabilities, work in conjunction with trustee endpoint devices 140 to distribute computational tasks effectively, thereby enhancing operational efficiency, maintaining high levels of data security, and verifying data integrity throughout trust management processes.

The trustee endpoint devices 140 may include an array of electronic devices equipped with edge computing capabilities for local data processing at each trustee location. These devices may include laptops, desktops, smartphones, and other computing devices configured to perform real-time data management tasks. Additionally, they may include specialized edge devices such as routers, integrated access devices (IADs), and network switches that facilitate seamless data flow across the network 110. The edge computing capabilities of the endpoint devices 140 enable real-time data validation, encryption, transaction management, and dynamic compliance monitoring, thereby providing enhanced data processing and connectivity specific to trust management operations.

The network 110 in the distributed computing environment 100 supports this decentralized architecture by providing a communication framework that spans various network types, including LAN, WAN, GAN, and the Internet. The network 110 may also incorporate advanced networking technologies such as software-defined networking (SDN), network function virtualization (NFV), and next-generation wireless communication standards like 5G. These technologies facilitate secure and efficient communication between the TMO system 130 and trustee endpoint devices 140, allowing for real-time data synchronization, secure data transmission, and collaborative processing. The network 110 may employ both secure and unsecure, wired, wireless, and optical interconnection technologies to accommodate diverse communication and processing needs, for robust and flexible connectivity throughout the trust management environment.

It is to be understood that the structure of the distributed edge computing environment 100 and its components, connections, relationships, and their functions are exemplary only and are not intended to limit implementations of the disclosures described and/or claimed in this document. In one example, the distributed edge computing environment 100 may include more, fewer, or different components than those depicted in FIG. 1A. In another example, some or all portions of the system 100 may be combined into a single portion, or all portions of the TMO system 130 may be separated into two or more distinct portions to better suit specific trust management needs and operational requirements.

FIG. 1B illustrates an exemplary component-level structure of the TMO system 130, in accordance with an embodiment of the disclosure. As shown in FIG. 1B, the TMO system 130 may be configured as an edge computing system that serves as a central management node within the distributed edge computing environment. The system 130 may include a processor 102, memory 104, input/output (I/O) device 116, and a storage device 110. These components work together to manage and coordinate data processing tasks, compliance monitoring, and secure communication across multiple trustee locations equipped with edge computing devices 140. By leveraging edge computing capabilities, the TMO system 130 can perform real-time data processing locally, reducing latency and enhancing the security and speed of trust management operations. The system 130 may also include a high-speed interface 108 connecting to the memory 104, facilitating rapid access to frequently used data and instructions. Additionally, a low-speed interface 112 connects to a low-speed bus 114 and storage device 110, enabling access to larger datasets and archival information that may not require frequent access. Each of the components 102, 104, 108, 110, and 112 may be operatively coupled using various buses and may be mounted on a common motherboard or in other configurations as appropriate. The processor 102 may include a number of subsystems specifically designed to execute portions of processes related to trust management and distributed data processing, enhancing the overall performance and reliability of the TMO system 130 within the broader network.

The processor 102 can process instructions associated with various applications that perform the functions disclosed herein, such as real-time data validation, encryption, transaction management, and compliance checks specific to trust management. As an edge computing system, the TMO system 130 may process these instructions locally, which are stored in the memory 104 (e.g., non-transitory storage device) or on the storage device 110. These instructions may be stored in the memory 104 (e.g., non-transitory storage device) or on the storage device 110 and are executed by the processor 102 to manage data flow and communication within the distributed network. The processor 102 may include specialized subsystems capable of executing algorithms for adaptive compliance monitoring, dynamic data synchronization, and secure communication with the trustee endpoint devices 140. The system 130 may be configured with multiple processors, each potentially handling different aspects of trust management processes, such as regulatory compliance or exposure assessment, to optimize performance and enhance system robustness.

The memory 104 stores information associated with the operation of the TMO system 130. In one implementation, the memory 104 is configured as volatile random-access memory (RAM), providing a cache area for temporary storage of instructions, operating states, and other information relevant to the current operation of the distributed computing environment 100. This configuration allows for rapid access and execution of processes related to trust management, such as immediate validation of incoming transactions from trustee endpoint devices 140 or real-time compliance checks against updated regulatory frameworks. In another implementation, the memory 104 may include non-volatile memory components such as EEPROM, flash memory, or magnetic or optical disks, which store persistent data, including audit trails, regulatory compliance records, and trust transaction histories. This data may be used for maintaining a comprehensive record of all trust activities and verifying data integrity across the distributed network. The memory 104 may store, recall, receive, transmit, and access various files and information used by the system 130 to maintain continuous, secure, and efficient trust management operations.

The storage device 106 provides mass storage capabilities for the TMO system 130 within the distributed edge computing environment. In one aspect, the storage device 106 may comprise or include a computer-readable medium, such as a hard disk drive, solid-state drive (SSD), optical disk device, tape device, or flash memory. The storage device 106 may also be part of a more extensive storage infrastructure, such as a storage area network (SAN) or a network-attached storage (NAS) system, which supports the high-volume data requirements of trust management. The storage device 106 may store a computer program product tangibly embodied in an information carrier that contains instructions executable by the processor 102 to perform various methods and functions, such as real-time data validation, secure data synchronization, compliance monitoring, and transaction management specific to the trust management processes. The information carrier may be a non-transitory computer- or machine-readable storage medium, which could be part of the memory 104, the storage device 106 itself, or integrated within the memory on the processor 102.

The high-speed interface 108 is configured to manage bandwidth-intensive operations for the TMO system 130, such as real-time processing of data received from multiple trustee endpoint devices 140, high-frequency transaction management, and dynamic compliance monitoring. The low-speed controller 112, on the other hand, manages operations that are less bandwidth-intensive, such as periodic data backups, archival storage access, and routine data synchronization tasks. This allocation of functions between the high-speed interface 108 and low-speed controller 112 is exemplary and can be customized depending on specific operational needs. In some embodiments, the high-speed interface 108 may be coupled to the memory 104 and the input/output (I/O) device 116, potentially through a graphics processor or accelerator, to facilitate rapid data processing and visualization. The high-speed interface 108 may also connect to high-speed expansion ports 111, which can accommodate various expansion cards to enhance the system's capabilities. Meanwhile, the low-speed controller 112 is coupled to the storage device 106 and low-speed expansion port 114, which may include various communication ports such as USB, Bluetooth, Ethernet, and wireless Ethernet. These ports may connect to input/output devices, like keyboards, pointing devices, scanners, or networking devices such as switches or routers, enabling the TMO system 130 to interface seamlessly with other devices within the distributed network.

The TMO system 130 may be implemented in various forms to suit different deployment scenarios within the distributed edge computing environment. For example, the system 130 may be configured as a standard server or replicated across multiple servers in a cluster to provide redundancy and load balancing, for reliable trust management operations. Alternatively, the system 130 could be part of a rack server system or implemented on a personal computer, such as a high-performance laptop, to provide flexibility in deployment. In other configurations, components of the TMO system 130 may be combined with other similar systems, or the entire system 130 may consist of multiple interconnected computing devices communicating over the network 110. This modular and flexible architecture allows the TMO system 130 to scale and adapt according to the specific needs of the trust management organization, providing robust support for decentralized, secure, and efficient trust management operations.

FIG. 1C illustrates an exemplary component-level structure of the endpoint device(s) 140, in accordance with an embodiment of the disclosure. As shown in FIG. 1C, the endpoint device(s) 140, deployed at trustee locations within the distributed edge computing environment, includes a processor 152, memory 154, an input/output device such as a display 156, a communication interface 158, and a transceiver 160, among other components. These components are configured to enable local processing of trust-related data, secure communication with the Trust Management Organization (TMO) system 130, and real-time execution of trust management functions. The endpoint device(s) 140 may also be equipped with a storage device, such as a microdrive or other solid-state storage, to provide additional capacity for storing transaction records, compliance data, and encrypted communications. Each of the components 152, 154, 158, and 160 are interconnected using various buses, and several of the components may be mounted on a common motherboard or in other suitable configurations to optimize space and processing efficiency.

The processor 152 is configured to execute instructions within the endpoint device(s) 140, including those stored in the memory 154, which in one embodiment contains the instructions of an application specifically designed for trust management operations. These instructions may include logic for processing financial transactions, performing compliance checks, managing data encryption, and synchronizing data with the TMO system 130. The processor 152 may be implemented as a chipset comprising multiple analog and digital processors, each responsible for different aspects of data processing and communication. For example, one processor may handle the coordination of other components within the endpoint device(s) 140, such as managing the control of user interfaces, executing applications related to trust management, and facilitating wireless communication with other devices on the network 110. This configuration ensures that each trustee location can independently process data and maintain secure and efficient operations without constant reliance on centralized systems.

The processor 152 may also be configured to interact with users through a control interface 164 and a display interface 166 connected to a display 156. The display 156 may utilize various technologies, such as TFT LCD (Thin-Film-Transistor Liquid Crystal Display) or OLED (Organic Light Emitting Diode) displays, to present graphical information, including real-time data on trust portfolio performance, transaction details, and compliance alerts. The display interface 166 comprises appropriate circuitry designed to drive the display 156, enabling it to render information clearly and responsively. The control interface 164 may receive input commands from a user—such as a trustee or administrator—and convert these commands into actions processed by the processor 152. Additionally, an external interface 168 may be provided to facilitate near-field communication (NFC) with other devices, supporting both wired and wireless communication protocols. This capability allows the endpoint device(s) 140 to communicate efficiently with nearby devices, such as local printers, scanners, or other networked devices, enhancing the overall flexibility and functionality of the trust management operations at each trustee location.

The memory 154 stores information within the endpoint device(s) 140, which are deployed at trustee locations within the distributed edge computing environment. The memory 154 can be implemented as one or more types of computer-readable media, including volatile memory units, such as RAM, or non-volatile memory units, such as flash memory or NVRAM. The memory 154 may be configured to store data associated with trust management operations, such as transaction records, compliance check results, encryption keys, and other operational data necessary for executing trust-related processes locally. Expansion memory may also be provided and connected to endpoint device(s) 140 through an expansion interface (not shown), which could include interfaces such as a SIMM (Single In Line Memory Module) card interface. This expansion memory may offer additional storage capacity for the endpoint device(s) 140 or store applications and other data, including secure information for enhanced data protection. In some embodiments, expansion memory may also include instructions to carry out or supplement the trust management processes described herein, providing an additional layer of security by functioning as a security module programmed with secure-use instructions. For example, the expansion memory may come in the form of a SIMM card containing secure applications and non-hackable identifying information, enhancing the overall security of the endpoint device(s) 140.

The memory 154 may include various types of memory, such as flash memory and/or NVRAM, to accommodate different data storage and retrieval requirements. In one aspect, a computer program product may be tangibly embodied in an information carrier contained within the memory 154. This computer program product includes instructions that, when executed by the processor 152, perform one or more trust management methods, such as real-time transaction validation, compliance monitoring, data synchronization with the TMO system 130, and secure communication with other devices within the distributed edge computing environment. The information carrier could be any computer- or machine-readable medium, such as the memory 154 itself, the expansion memory, memory on the processor 152, or even a propagated signal that may be received over the transceiver 160 or external interface 168. This flexibility in storage and memory configuration ensures that the endpoint device(s) 140 are well-equipped to handle the diverse data management tasks required in a distributed trust management system.

In some embodiments, a user, such as a trustee or administrator, may use the endpoint device(s) 140 to transmit and/or receive information or commands to and from the TMO system 130 via the network 110. Communication between the TMO system 130 and the endpoint device(s) 140 may be governed by an authentication protocol such that only authenticated users (or processes) are granted access to protected resources of the TMO system 130, such as servers, databases, applications, and other components described herein. To this end, the TMO system 130 may initiate an authentication subsystem that requires the user (or process) to provide authentication credentials, such as a username, password, biometric data, or digital certificates, to verify their identity and determine their eligibility to access protected resources. Upon successful validation of the authentication credentials, the authentication subsystem may grant the user (or process) permissioned access to the protected resources. Similarly, the endpoint device(s) 140 may implement authentication measures to provide the TMO system 130 (or other client devices) with permissioned access to its protected resources, which may include hardware components such as a GPS device, an image capturing component (e.g., camera), a microphone, and a speaker. This mutual authentication process improves the overall security of trust management operations such that both the TMO system 130 and the trustee endpoint device(s) 140 can securely share and access sensitive data.

The endpoint device(s) 140 may communicate with the TMO system 130 through the communication interface 158, which may include digital signal processing circuitry where necessary to support various communication modes or protocols. The communication interface 158 may support communications under protocols such as the Internet Protocol (IP) suite (commonly known as TCP/IP), which defines end-to-end data handling methods including packetizing, addressing, routing, and data receipt. The IP suite may be broken down into layers: the link layer for communication within a single network segment, the Internet layer for internetworking between independent networks, the transport layer for host-to-host communication, and the application layer for process-to-process data exchange. Each of these layers contains a stack of protocols used for communications. Additionally, the communication interface 158 may support telecommunications standards (e.g., 2G, 3G, 4G, 5G) and their respective layered protocol stacks, facilitating robust and flexible communication capabilities. Communications may occur through the transceiver 160, such as a radio-frequency transceiver, to enable wireless communication across various network types. Furthermore, the endpoint device(s) 140 may support short-range communication methods, such as Bluetooth, Wi-Fi, or other similar transceivers (not shown), to communicate with nearby devices. The GPS receiver module 170 may provide additional navigation and location-related data to the endpoint device(s) 140, which may be utilized by trust management applications running on the devices, and in some embodiments, by applications operating on the TMO system 130.

The endpoint device(s) 140 may also facilitate audio communication using an audio codec 162, which is capable of receiving spoken information from a user and converting it into digital information that can be processed by the device. The audio codec 162 may also generate audible sound for the user, such as through a speaker embedded in the device (e.g., in a handset or integrated speaker system). This sound may include audio from voice telephone calls, recorded sounds such as voice messages or music files, and sounds generated by one or more applications operating on the endpoint device(s) 140. In some embodiments, the audio codec 162 may also interact with applications running on the TMO system 130, providing an integrated audio-visual communication experience that supports efficient trust management operations. This capability allows trustees to receive real-time audio alerts or instructions from the TMO system 130 or to interact with other stakeholders in a secure and effective manner.

Various implementations of the distributed edge computing environment, including the TMO system 130 and trustee endpoint device(s) 140, as well as the techniques described herein, can be realized through a combination of digital electronic circuitry, integrated circuitry, specially designed application-specific integrated circuits (ASICs), computer hardware, firmware, software, and/or combinations thereof. For example, the TMO system 130 may leverage integrated circuitry and ASICs to perform high-speed data processing, compliance monitoring, and secure data management functions, while the trustee endpoint device(s) 140 may utilize firmware and software to execute trust management applications locally, facilitate secure communications, and manage data synchronization with the TMO system 130. These diverse implementations provide flexibility in how the distributed edge computing environment is deployed, allowing for scalable, secure, and efficient data management tailored to the specific needs of trust management operations. The use of a combination of hardware and software components ensures that both the TMO system 130 and the trustee endpoint device(s) 140 can perform complex computational tasks and handle dynamic data management requirements effectively within a distributed network architecture.

It is to be understood that the configurations and component arrangements depicted in FIGS. 1A, 1B, and 1C are illustrative embodiments of the disclosure and are provided for the purpose of describing specific examples of the system environment, including the TMO system 130 and trustee endpoint device(s) 140. These illustrations are not intended to limit the scope of the disclosure in any way. Various modifications, adaptations, and alternative configurations of the components and systems described herein may be employed without departing from the spirit and scope of the disclosure. For example, components shown as separate in the figures may be combined into a single component, or a single component may be divided into multiple components. Similarly, the specific hardware, firmware, or software used in each component may vary, and the system environment may be implemented using any suitable combination of digital electronic circuitry, integrated circuitry, ASICs, computer hardware, firmware, software, or combinations thereof. The disclosure is not limited to the specific embodiments described and may be adapted to various environments and applications. Any changes or substitutions that fall within the meaning and range of equivalency of the claims are intended to be embraced within the scope of the disclosure.

### Example Machine Learning Subsystem Architecture

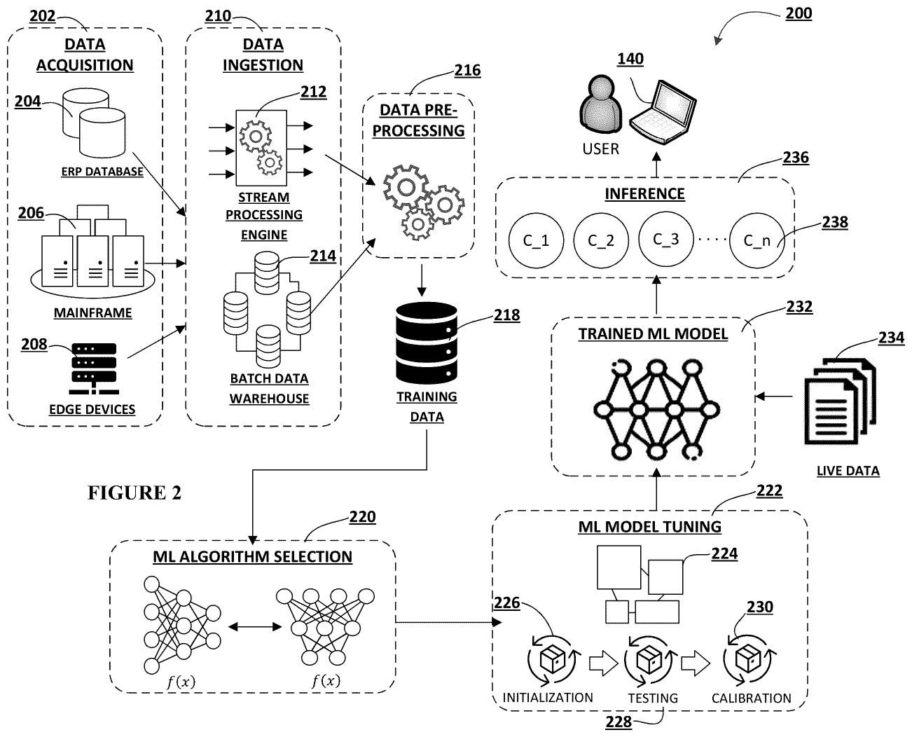

FIG. 2 illustrates an example machine learning (ML) subsystem architecture 200, in accordance with an embodiment of the invention. The ML subsystem 200 may be integrated within the TMO system 130 and may operate locally on the TMO system to enable real-time analytics, monitoring, and decision-making in trust management operations. The ML subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. For the TMO system 130, these internal and/or external data sources 204, 206, and 208 may include sources (e.g., trustee endpoint device 140) where trust-related data originates or where physical trust documents are first digitized. The data acquisition engine 202 may identify the location of the data, such as trustee endpoint devices 140, and describes connection characteristics for access and retrieval of data. In some embodiments, data may be transported from each data source 204, 206, or 208 to the TMO system 130 using network protocols like File Transfer Protocol (FTP), Hyper-Text Transfer Protocol (HTTP), or Application Programming Interfaces (APIs) provided by various networked applications and services. These data sources may include Enterprise Resource Planning (ERP) databases that host data related to trust management activities such as accounting, investment performance, regulatory compliance, and exposure management. Other sources may include mainframes serving as central data processing centers or edge devices like trustee endpoint devices 140 that collect and transmit real-time data about trust transactions and compliance status. The data acquired by the data acquisition engine 202 from these sources may then be transported to the data ingestion engine 210 for further processing.

Depending on the nature of the data imported from the data acquisition engine 202, the data ingestion engine 210 may move the data to a designated location for storage or further analysis. The imported data may come in various formats, such as RDBMS, other types of databases, S3 buckets, CSVs, or data streams from trustee endpoint devices 140. Given the diverse origins of the data, it must be cleansed and transformed to enable integrated analysis with data from other sources. At the data ingestion engine 210, the data may be ingested in real-time using a stream processing engine 212 or in batches using a batch data warehouse 214, or a combination of both. The stream processing engine 212 processes continuous data streams, such as real-time transaction data from trustee endpoint devices 140, computing on data directly as it is received, and filters the incoming data to retain specific portions deemed useful by aggregating, analyzing, transforming, and ingesting the data. Conversely, the batch data warehouse 214 collects and transfers data in batches according to scheduled intervals, trigger events, or other logical ordering, facilitating periodic analysis of trust management activities.

In machine learning, the quality of data and the useful information that may be derived therefrom directly affects the ability of the machine learning model 224 to learn effectively. The data pre-processing engine 216 may implement advanced integration and processing steps to prepare the data for machine learning execution. This preparation may include modules designed to perform data transformation, consolidating the data into alternate forms by changing the value, structure, or format of the data using techniques such as generalization, normalization, attribute selection, and aggregation. The data pre-processing engine 216 may also perform data cleaning tasks, which may involve filling in missing values, smoothing noisy data, resolving inconsistencies, and removing outliers, as well as any other encoding steps that may be necessary.

In addition to improving the quality of the data, the data pre-processing engine 216 may implement feature extraction and/or selection techniques to generate training data 218. Feature extraction and/or selection may involve dimensionality reduction processes by which an initial set of data is reduced to more manageable groups for processing. For the TMO system 130, which may handle large volumes of trust-related data from trustee endpoint devices 140, this process may be implemented to optimize computing resources. Feature extraction and/or selection may be used to select and/or combine variables into features, effectively reducing the amount of data that must be processed while still accurately representing the original data set. Depending on the type of machine learning algorithm being employed, this training data 218 may require further enrichment. For example, in supervised learning scenarios, the training data may be enriched using one or more meaningful and informative labels to provide context, allowing the machine learning model to learn from it effectively. Labels may be used to identify specific features, such as whether a transaction is compliant or non-compliant, or if a series of transactions indicates a potential exposure. Data labeling may be required for various use cases, including anomaly detection, exposure assessment, and compliance monitoring within trust management. In contrast, unsupervised learning may use unlabeled data to identify patterns, such as inferences or clustering of data points, which may be used for identifying trends or detecting unusual behavior in trust management operations.

The ML model tuning engine 222 may be used to train a machine learning model 224 using the training data 218 to make predictions or decisions without the need for explicit programming instructions. In the context of trust management, the machine learning model 224 may represent patterns and insights learned by a selected machine learning algorithm 220 and may include rules, numerical values, and other algorithm-specific data structures required for tasks such as classification, anomaly detection, or exposure assessment. Selecting the appropriate machine learning algorithm 220 may depend on various factors, such as the specific problem statement, the type of output required, the nature and size of the trust-related data received from trustee endpoint devices 140, the available computational resources, the number of features and observations in the data, and other relevant considerations. Machine learning algorithms may refer to programs that are mathematically and logically configured to self-adjust and improve performance as they process more data. Accordingly, these algorithms may be capable of adjusting their parameters based on feedback from previous performance in predicting or analyzing datasets, allowing the TMO system 130 to refine its predictive accuracy and decision-making capabilities over time.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220. This process refines the results to prepare the model for deployment for consumption or decision-making within trust management operations. The ML model tuning engine 222 may dynamically vary hyperparameters during each iteration (e.g., the number of trees in a tree-based algorithm or the value of alpha in a linear algorithm), rerun the algorithm on the data, and then compare its performance on a validation set to determine which set of hyperparameters yields the most accurate model. The model's accuracy is used to assess which hyperparameter set best identifies relationships and patterns between variables in a dataset based on the input, or training data 218. A fully trained machine learning model 232 is one whose hyperparameters have been tuned to maximize model accuracy, enabling the TMO system 130 to effectively analyze trust-related data and provide actionable insights.

The trained machine learning model 232 may be persisted to storage, file, memory, or an application within the TMO system 130, or it may be looped back into the processing component for further reprocessing. More commonly, the trained machine learning model 232 is deployed into an existing production environment of the TMO system 130 to make practical business decisions based on live data 234 received from trustee endpoint devices 140. To facilitate this, the machine learning subsystem 200 utilizes the inference engine 236 to execute decision-making processes. The type of decision-making may depend on the machine learning algorithm employed. For example, machine learning models trained with supervised learning algorithms may structure computations in terms of categorized outputs (e.g., C_1, C_2 . . . C_n 238) or observations based on defined classifications. These models may represent possible solutions to a decision based on certain conditions, model complex relationships between inputs and outputs to detect patterns in data, or capture a statistical structure among variables with unknown relationships. In contrast, machine learning models trained with unsupervised learning algorithms may be used to group (e.g., C_1, C_2 . . . C_n 238) live data 234 received from trustee endpoint devices 140 based on similarities, addressing exploratory challenges where little is known about the data. These models may provide a description or label (e.g., C_1, C_2 . . . C_n 238) to the live data 234, such as in classification tasks. These categorized outputs, groups (clusters), or labels are then presented to the TMO system 130 for further analysis or action. Additionally, machine learning models that perform regression techniques may use live data 234 to predict or forecast continuous outcomes, aiding in proactive decision-making in trust management.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

### Example Methods for Enhanced Data Management Using Distributed Edge Computing

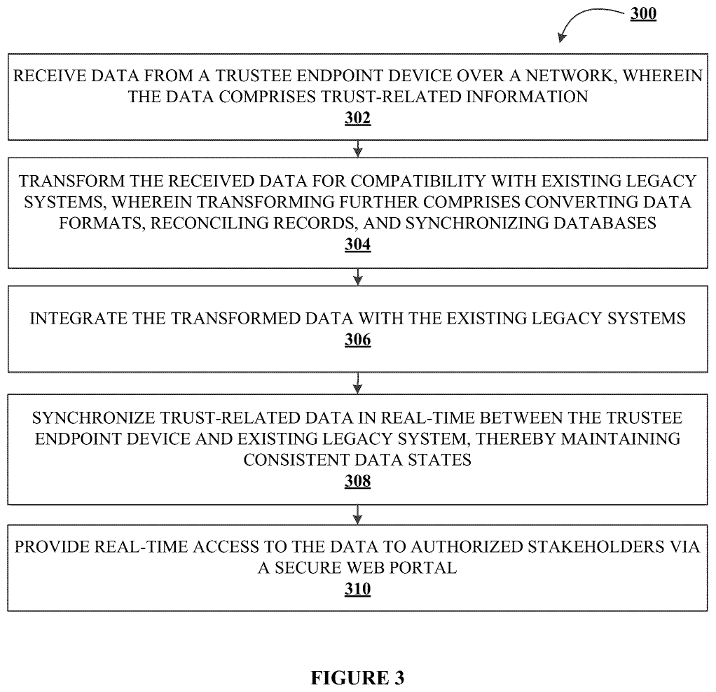

FIG. 3 illustrates an example method 300 for synchronizing trust-related data between trustee endpoint device and existing legacy system, in accordance with an embodiment of the invention. The method 300 may be executed by a TMO system 130 configured with edge computing capabilities, enabling real-time processing and data synchronization with trustee endpoint devices 140 over a network.

As shown in block 302, the method begins with the TMO system 130 receiving data from a trustee endpoint device over a network, where the data comprises trust-related information. The data may include transaction records, beneficiary information, compliance documents, or any other relevant financial data necessary for trust management operations. The TMO system 130 may utilize secure communication protocols to ensure the data transmission is encrypted and protected against unauthorized access, thereby maintaining data integrity and confidentiality during transit. The data reception step may leverage the edge computing capabilities of both the TMO system 130 and trustee endpoint devices 140, enabling the processing of data at the network edge to reduce latency and improve processing speed.

As shown in block 304, upon receiving the data, the TMO system 130 may transform the received data for compatibility with existing legacy systems. The transformation process may involve converting data formats, reconciling records, and synchronizing databases to ensure seamless integration with legacy infrastructures. The TMO system 130, equipped with edge computing capabilities, may perform these transformations locally to improve processing efficiency and reduce the need for centralized processing. The data transformation step ensures that the trust-related data can be effectively utilized alongside legacy systems without compatibility issues, thereby supporting seamless data integration across the trust management ecosystem.

As shown in block 306, the transformed data is then integrated with the existing legacy systems. The TMO system 130 may execute this integration by interfacing directly with legacy system databases and applications, such that the transformed data is correctly aligned with existing data structures and formats. This step may involve updating legacy databases, adjusting data schemas, or modifying data access protocols to accommodate the newly transformed data. By integrating data at the edge, the TMO system 130 may improve the responsiveness of trust management operations and maintains consistency across both modern and legacy systems.

As shown in block 308, the TMO system 130 synchronizes trust-related data in real-time between the trustee endpoint devices and the existing legacy systems, thereby maintaining consistent data states. This real-time synchronization may utilize distributed edge computing techniques such that that any changes or updates made on one device are promptly reflected across all other devices and systems within the network. The synchronization process may be facilitated by a combination of push and pull mechanisms, where data changes are either pushed from the TMO system 130 to the trustee endpoint devices 140 or pulled by the trustee endpoint devices as required. This step ensures data consistency and accuracy across the entire trust management network, enabling stakeholders to make informed decisions based on the most up-to-date information.

In some embodiments, the TMO system 130 may log the exposure activities or potential compliance breaches in a secure, immutable audit trail stored locally. This audit trail may be configured to provide a tamper-proof record of all compliance monitoring activities, including the details of each identified breach or exposure and the corresponding alerts generated. The secure, immutable nature of the audit trail ensures that all records remain intact and unaltered, thereby supporting regulatory compliance and enabling thorough audits of trust management practices. The use of edge computing allows the TMO system 130 to maintain these audit trails locally, reducing the exposure of data breaches and allowing for high availability for compliance verification purposes.

As shown in block 310, the TMO system 130 may provide real-time access to the data for authorized stakeholders via a secure web portal. The web portal may be designed to display synchronized trust-related data, including transaction logs, compliance records, and audit trails, allowing stakeholders such as trustees, beneficiaries, and regulators to access the data securely and in real-time. The TMO system 130 may implement robust authentication and authorization protocols such that only authorized users can access sensitive trust information. By leveraging edge computing capabilities, the TMO system 130 can provide high-speed, low-latency access to trust data, thereby enhancing transparency and trust among all stakeholders involved.

In some embodiments, in addition to data synchronization, the TMO system 130 may execute compliance monitoring algorithms on the real-time transaction data for analysis against current regulatory requirements and predefined compliance rules, as shown in block 308. The TMO system 130, leveraging its edge computing capabilities, processes this data locally to identify any exposure activities or potential compliance breaches. The system may employ advanced machine learning models or rule-based algorithms to detect patterns indicative of non-compliance or exposure. If any exposure activities or potential compliance breaches are identified, the TMO system 130 generates an alert. This alert may contain detailed information about the identified issue and is transmitted to the trustee endpoint device for immediate awareness and prompt corrective action.

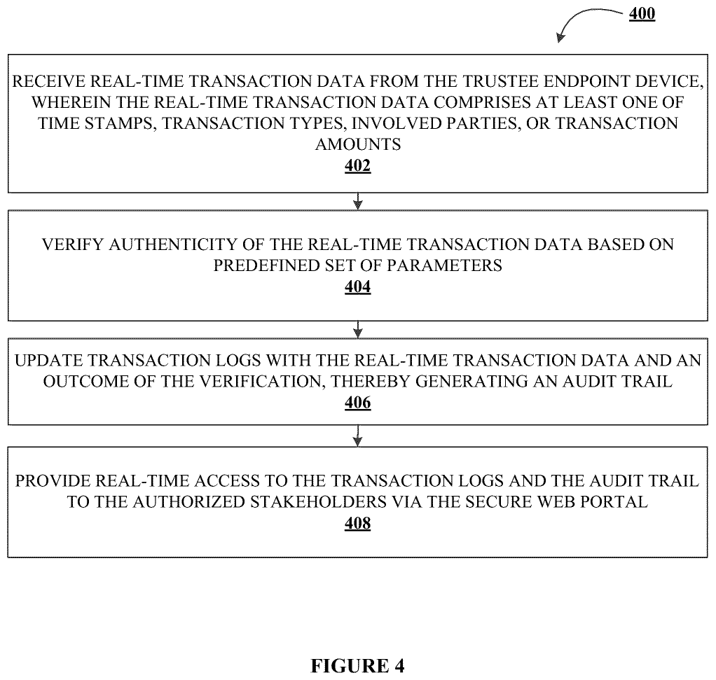

FIG. 4 illustrates an example method 400 for continuously updating transaction logs with real-time transaction data, in accordance with an embodiment of the invention. The method 400 may be implemented by the TMO system 130, utilizing its edge computing capabilities to perform real-time data verification, logging, and secure access management, for transparency and accuracy in trust management operations.

As shown in block 402, the method begins with the TMO system 130 receiving real-time transaction data from a trustee endpoint device over a network. The real-time transaction data may include various elements such as timestamps, transaction types, involved parties, or transaction amounts, such that all transactions are accurately captured and documented. The TMO system 130 may employ secure communication protocols to receive this data, leveraging edge computing capabilities to process the data locally and minimize latency.

As shown in block 404, upon receiving the real-time transaction data, the TMO system 130 may verify the authenticity of the data based on a predefined set of parameters. These parameters may include checks for data integrity, compliance with trust agreements, and verification against known data patterns or regulatory requirements. The verification process may utilize advanced algorithms and machine learning models hosted on the TMO system 130 to detect any anomalies or irregularities in the transaction data. By performing these checks locally, the TMO system 130 ensures that the data is both accurate and compliant with relevant regulations before being further processed or stored.

As shown in block 406, the TMO system 130 may then update the transaction logs with the verified real-time transaction data and the outcome of the verification process. This step may involve recording the details of each transaction, including its timestamp, type, involved parties, and amount, along with the verification results. The process of updating the transaction logs generates an audit trail, which serves as a secure, immutable record of all transactions and their verification statuses. This audit trail may be used for maintaining transparency and accountability in trust management, as it allows stakeholders to trace each transaction back to its source and verify its authenticity.

As shown in block 408, the TMO system 130 may provide real-time access to the updated transaction logs and audit trails to authorized stakeholders via a secure web portal. The web portal may be configured to display comprehensive details of each transaction and its associated verification status, allowing stakeholders such as trustees, beneficiaries, and regulators to access this information in real-time. The TMO system 130 may implement access control mechanisms such that only authorized users can view or interact with the sensitive data. By utilizing edge computing to facilitate rapid data access and display, the TMO system 130 enhances the transparency and trustworthiness of trust management operations, enabling stakeholders to make informed decisions based on accurate and timely information.

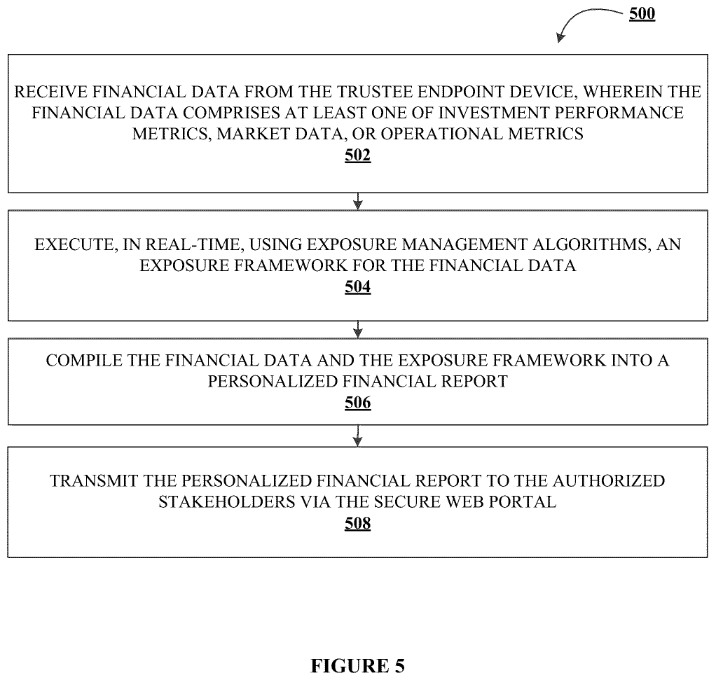

FIG. 5 illustrates an example method 500 for generating a personalized financial report, in accordance with an embodiment of the invention. The method 500 may be executed by the TMO system 130, utilizing its edge computing capabilities to process financial data in real-time and generate reports that provide valuable insights for trust management.

As shown in block 502, the process flow begins with the TMO system 130 receiving financial data from a trustee endpoint device over a network. The financial data may comprise at least one of investment performance metrics, market data, or operational metrics. This data may be used for assessing the current state of trust resources, monitoring market conditions, and evaluating the operational efficiency of trust management activities. The TMO system 130 may use secure communication protocols to receive this data, such that the data transmission is encrypted and protected from unauthorized access. By leveraging edge computing capabilities, the TMO system 130 processes this data locally, minimizing latency and enhancing the speed of data reception and analysis.

As shown in block 504, after receiving the financial data, the TMO system 130 may execute, in real-time, exposure management algorithms to construct an exposure framework for the financial data. These algorithms may analyze various exposure factors, such as market volatility, credit exposure, and operational exposures, to assess the trust's overall exposure portfolio. The execution of these algorithms may be performed locally on the TMO system 130, utilizing its edge computing capabilities to rapidly compute and analyze large datasets. This real-time processing allows the TMO system 130 to provide up-to-date exposure assessments that reflect current market conditions and trust resource performance.

As shown in block 506, the TMO system 130 then compiles the financial data and the generated exposure framework into a personalized financial report. This report may include detailed information on investment performance, market conditions, exposure assessments, and operational metrics, tailored to meet the specific needs of the trust and its stakeholders. The report generation process may involve organizing and formatting the data for clarity and comprehensibility, as well as applying data visualization techniques to present complex information in a user-friendly manner. By performing these tasks locally, the TMO system 130 leverages edge computing to enhance report generation speed and accuracy, providing stakeholders with timely and relevant financial insights.

As shown in block 508, the TMO system 130 may transmit the personalized financial report to authorized stakeholders via a secure web portal. The web portal may be configured to provide secure, real-time access to the report, allowing stakeholders such as trustees, beneficiaries, and regulators to view, download, or interact with the data as needed. The TMO system 130 may implement encryption and authentication mechanisms such that only authorized users have access to the report, thereby maintaining data privacy and security. By utilizing edge computing to facilitate rapid data transmission and access, the TMO system 130 ensures that stakeholders receive the most current and accurate information for informed decision-making.

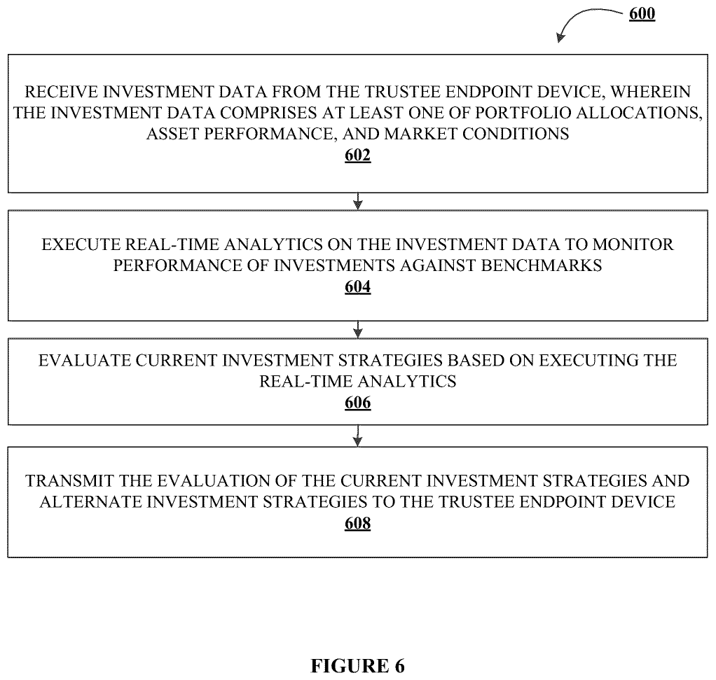

FIG. 6 illustrates an example method 600 for generating a personalized financial report, in accordance with an embodiment of the invention. The method 600 may be executed by the TMO system 130, utilizing its edge computing capabilities to process investment data in real-time and provide actionable insights to trustee endpoint devices 140.

As shown in block 602, the method begins with the TMO system 130 receiving investment data from a trustee endpoint device over a network. The investment data may comprise at least one of portfolio allocations, resource performance, and market conditions. This data may be used for assessing the performance of trust investments and determining the effectiveness of current investment strategies. The TMO system 130 may use secure communication protocols to receive this data, such that the transmission is encrypted and protected from unauthorized access. By leveraging its edge computing capabilities, the TMO system 130 processes this data locally, reducing latency and enhancing the speed and efficiency of data analysis.

As shown in block 604, after receiving the investment data, the TMO system 130 may execute real-time analytics on the data to monitor the performance of investments against established benchmarks. These analytics may involve the use of various statistical models, machine learning algorithms, or financial analysis tools designed to evaluate investment performance metrics such as return on investment, volatility, exposure-adjusted returns, and other relevant indicators. By performing these analyses locally, the TMO system 130 utilizes its edge computing capabilities to rapidly compute and evaluate large datasets, providing timely insights into investment performance relative to market conditions and benchmarks.

As shown in block 606, based on the results of the real-time analytics, the TMO system 130 may evaluate the current investment strategies employed by the trust. This evaluation may include assessing the effectiveness of existing portfolio allocations, resource selections, and exposure management strategies. The system may compare current performance metrics against benchmarks and historical performance data to identify any deviations or areas of concern. Additionally, the TMO system 130 may generate recommendations for optimizing investment strategies based on the analysis, such as reallocating resources, adjusting portfolio weightings, or altering exposure management approaches.

As shown in block 608, the TMO system 130 may transmit the evaluation of the current investment strategies and any alternate investment strategies to the trustee endpoint device. This transmission may occur through secure communication channels for data privacy and integrity. The evaluation and recommendations may be presented in a format that is easy to understand and actionable, allowing trustees to quickly implement suggested changes or adjust their strategies as needed. By utilizing its edge computing capabilities to facilitate real-time analysis and secure data transmission, the TMO system 130 improves the responsiveness and effectiveness of investment management within the trust environment.

In some embodiments, the TMO system 130 may receive, from a trustee endpoint device, a notification of a trustee change. Upon receiving this notification, the TMO system 130 may execute a backup of metadata associated with transactions executed using the trustee endpoint device. This metadata may comprise relevant trust data, records, or transaction histories associated with the current trustee. The TMO system 130, utilizing its edge computing capabilities, performs this backup operation locally for data integrity and security. The backed-up metadata is then synchronized with a new trustee endpoint device for a seamless transition and continuity in trust management operations. This synchronization process ensures that the new trustee endpoint device has immediate access to all necessary data and records, thereby maintaining the consistency and accuracy of trust management activities across the network.

In some embodiments, the TMO system 130 may update access controls and permissions associated with the new trustee endpoint device to mirror those of the previous trustee endpoint device. This process involves modifying access control lists, user roles, and permissions such that the new trustee has the appropriate level of access to trust-related data and functionalities. The TMO system 130 may utilize secure authentication protocols and edge computing capabilities to perform these updates locally, minimizing latency and enhancing security. By dynamically adjusting access controls and permissions in real-time, the TMO system 130 ensures that only authorized users can access sensitive trust information, thereby maintaining robust data security and compliance with regulatory requirements.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A trust management organization (TMO) system for enhanced data management using distributed edge computing, the system comprising:
a processor;
a non-transitory storage device containing instructions that, when executed by the processor, cause the processor to:
receive an indication of data reception from a trustee endpoint device over a network, wherein the data comprises trust-related information;
trigger the trustee endpoint device to transform the data for compatibility with existing legacy systems prior to transmission, wherein transforming further comprises converting data formats, reconciling records, and synchronizing databases;
receive the transformed data from the trustee endpoint device;
integrate the transformed data with the existing legacy systems;
synchronize trust-related data in real-time via direct device-to-device communication between the trustee endpoint device and existing legacy system using push-pull synchronization mechanism, thereby maintaining consistent data states;
execute a locally stored machine learning model to analyze the real-time transaction data against current regulatory requirements and predefined compliance rules to identify exposure activities or potential compliance breaches;
in an instance in which exposure activities or potential compliance breaches is identified, generate an alert;
transmit the alert to the trustee endpoint device; and
in an instance in which no exposure activities or potential compliance breaches are identified, provide real-time access to the data to authorized stakeholders via a secure web portal,
wherein the TMO system and the trustee endpoint device are edge computing devices.

2. The TMO system of claim 1, wherein the instructions, when executed by the processor, further cause the processor to:
receive real-time transaction data from the trustee endpoint device, wherein the real-time transaction data comprises at least one of time stamps, transaction types, involved parties, or transaction amounts;
verify authenticity of the real-time transaction data based on predefined set of parameters;
update transaction logs with the real-time transaction data and an outcome of the verification, thereby generating an audit trail; and
provide real-time access to the transaction logs and the audit trail to the authorized stakeholders via the secure web portal.

3. (canceled)

4. The TMO system of claim 3, wherein the instructions, when executed by the processor, further cause the processor to:
log the exposure activities or potential compliance breaches in a secure, immutable audit trail stored locally on the TMO system.

5. The TMO system of claim 1, wherein the instructions, when executed by the processor, further cause the processor to:
receive financial data from the trustee endpoint device, wherein the financial data comprises at least one of investment performance metrics, market data, or operational metrics;
execute, in real-time, using exposure management algorithms, an exposure framework for the financial data;
compile the financial data and the exposure framework into a personalized financial report; and
transmit the personalized financial report to the authorized stakeholders via the secure web portal.

6. The TMO system of claim 1, wherein the instructions, when executed by the processor, further cause the processor to:
receive investment data from the trustee endpoint device, wherein the investment data comprises at least one of portfolio allocations, resource performance, and market conditions;
execute real-time analytics on the investment data to monitor performance of investments against benchmarks;
evaluate current investment strategies based on executing the real-time analytics; and
transmit the evaluation of the current investment strategies and alternate investment strategies to the trustee endpoint device.

7. The TMO system of claim 1, wherein the instructions, when executed by the processor, further cause the processor to:
receive, from the trustee endpoint device, a notification of a trustee change;
execute a backup of metadata associated with transactions executed using the trustee endpoint device, wherein the metadata comprises at least one of relevant trust data, records, or transaction histories associated with a current trustee; and
synchronize the metadata with a new trustee endpoint device.

8. The TMO system of claim 7, wherein, in synchronizing the metadata, the instructions, when executed by the processor, further cause the processor to:
update access controls and permissions with the new trustee endpoint device to mirror access controls and permissions associated with the trustee endpoint device.

9. A computer program product for enhanced data management using distributed edge computing, the computer program product comprising a non-transitory computer-readable medium comprising code configured to cause an apparatus to:
receive an indication of data reception from a trustee endpoint device over a network, wherein the data comprises trust-related information;
trigger the trustee endpoint device to transform the data for compatibility with existing legacy systems prior to transmission, wherein transforming further comprises converting data formats, reconciling records, and synchronizing databases;
receive the transformed data from the trustee endpoint device;
integrate the transformed data with the existing legacy systems;
synchronize trust-related data in real-time via direct device-to-device communication between the trustee endpoint device and existing legacy system using push-pull synchronization mechanism, thereby maintaining consistent data states;
execute a locally stored machine learning model to analyze the real-time transaction data against current regulatory requirements and predefined compliance rules to identify exposure activities or potential compliance breaches;
in an instance in which exposure activities or potential compliance breaches is identified, generate an alert;
transmit the alert to the trustee endpoint device; and
in an instance in which no exposure activities or potential compliance breaches are identified, provide real-time access to the data to authorized stakeholders via a secure web portal,
wherein the TMO system and the trustee endpoint device are edge computing devices.

10. The computer program product of claim 9, wherein the code further causes the apparatus to:
receive real-time transaction data from the trustee endpoint device, wherein the real-time transaction data comprises at least one of time stamps, transaction types, involved parties, or transaction amounts;
verify authenticity of the real-time transaction data based on predefined set of parameters;
update transaction logs with the real-time transaction data and an outcome of the verification, thereby generating an audit trail; and
provide real-time access to the transaction logs and the audit trail to the authorized stakeholders via the secure web portal.

11. (canceled)

12. (canceled)

13. The computer program product of claim 12, wherein the code further causes the apparatus to:
log the exposure activities or potential compliance breaches in a secure, immutable audit trail; and
store the log in a local memory.

14. The computer program product of claim 9, wherein the code further causes the apparatus to:
receive financial data from the trustee endpoint device, wherein the financial data comprises at least one of investment performance metrics, market data, or operational metrics;
execute, in real-time, using exposure management algorithms, an exposure framework for the financial data;
compile the financial data and the exposure framework into a personalized financial report; and
transmit the personalized financial report to the authorized stakeholders via the secure web portal.

15. The computer program product of claim 9, wherein the code further causes the apparatus to:
receive investment data from the trustee endpoint device, wherein the investment data comprises at least one of portfolio allocations, resource performance, and market conditions;
execute real-time analytics on the investment data to monitor performance of investments against benchmarks;
evaluate current investment strategies based on executing the real-time analytics; and
transmit the evaluation of the current investment strategies and alternate investment strategies to the trustee endpoint device.

16. The computer program product of claim 9, wherein the code further causes the apparatus to:
receive, from the trustee endpoint device, a notification of a trustee change;
execute a backup of metadata associated with transactions executed using the trustee endpoint device, wherein the metadata comprises at least one of relevant trust data, records, or transaction histories associated with a current trustee; and
synchronize the metadata with a new trustee endpoint device.

17. A method for enhanced data management using distributed edge computing, the method comprising:
receiving an indication of data reception from a trustee endpoint device over a network, wherein the data comprises trust-related information;
triggering the trustee endpoint device to transform the data for compatibility with existing legacy systems prior to transmission, wherein transforming further comprises converting data formats, reconciling records, and synchronizing databases;
receiving the transformed data from the trustee endpoint device;
integrating the transformed data with the existing legacy systems;
synchronizing trust-related data in real-time via direct device-to-device communication between the trustee endpoint device and existing legacy system using push-pull synchronization mechanism, thereby maintaining consistent data states;
executing a locally stored machine learning model to analyze the real-time transaction data against current regulatory requirements and predefined compliance rules to identify exposure activities or potential compliance breaches;
in an instance in which exposure activities or potential compliance breaches is identified. generating an alert;
transmitting the alert to the trustee endpoint device; and
in an instance in which no exposure activities or potential compliance breaches are identified, providing real-time access to the data to authorized stakeholders via a secure web portal,
wherein the TMO system and the trustee endpoint device are edge computing devices.

18. The method of claim 17, wherein the method further comprises:
receiving real-time transaction data from the trustee endpoint device, wherein the real-time transaction data comprises at least one of time stamps, transaction types, involved parties, or transaction amounts;
verifying authenticity of the real-time transaction data based on predefined set of parameters;
updating transaction logs with the real-time transaction data and an outcome of the verification, thereby generating an audit trail; and
providing real-time access to the transaction logs and the audit trail to the authorized stakeholders via the secure web portal.

19. (canceled)

20. The method of claim 19, wherein the method further comprises:
logging the exposure activities or potential compliance breaches in a secure, immutable audit trail; and
storing the log in a local memory.

21. The computer program product of claim 16, wherein the code further causes the apparatus to:
update access controls and permissions with the new trustee endpoint device to mirror access controls and permissions associated with the trustee endpoint device.
